(19) United States
(12) Patent Application Publication
(10) Pub. No.: US 2011/0126779 A1
(43) Pub. Date: Jun. 2, 2011

(54) Doggie's bathroom bag

(76) Inventor: Linda Fay Walls, Matteson, IL (US)

(21) Appl. No.: 12/804,389

(22) Filed: Jul. 21, 2010

Related U.S. Application Data
(60) Provisional application No. 61/229,408, filed on Jul. 29, 2009.

(51) Int. Cl. A01K 23/00

(52) U.S. Cl. 119/868

(57) ABSTRACT

A removable water resistant cloth bag that can be used with or without a disposable bag directly on the animal's body by a harness that can be worn to catch urine, feces or both forms of waste. There may be a back strap that may connect to a dog's collar, two side straps that connect around the dog's chest, and straps connects to the side straps over the dogs shoulders behind the head, two nylon straps or bra straps that wraps and adjust to fit around the dog's hind legs, all the straps may utilize hook, loop fasteners, side release snaps, the bottom section may be where the bag can be attached; the top section the dog's tail may be inserted, the bag may then be positioned to catch urine, lined with an absorbent lining, or to collect feces, a longer bag may catch all waste at the same time.

### CROSS REFERENCE TO RELATED APPLICATIONS

This application is based on provisional application Ser. No. 61/229,408, filed on Jul. 29, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of waste management of dog's excrement and urine, and more specifically to the use of doggie's Bathroom Bag, a harness worn by a dog with an attachable removable water resistance bag with or without the use of a disposable bag to catch the dog's excrement or urine.

Many dog owners want to take responsibility for the mess left by their animal, but sometimes it is not convenient to carry a bag of waste around. A user may be on a long walk with their animal and be turned off by the idea of having to keep a bag of dog waste in their pocket the entire time; walking multiple dogs at once can only increase the difficulty of doing so, Having to make potentially messy hand to waste contact in order to clean up after a dog can have some pet owners leaving the waste behind creating an eyesore and other problems for those who pass by.

Doggie's Bathroom Bag provides pet owners with a simple way to clean up their animal's waste while walking without having to touch the excrement. A Dog's Excrement Catcher to catch urine and feces of a dog. The dog's excrement catcher is shaped like a sling or harness with a removable water resistant cloth material bag that can be used with or without a disposable bag. More specifically, the dog's excrement catcher is put on the dog's rear end, fitting closely around the tail with the removable bag attached to it directly under the tail. The Dog's Excrement Catcher is worn by the dog when taking the dog out for a walk. The Dog's Excrement Catcher catches the urine or feces as the dog squats or lifts to excrete urine or feces. The urine and feces are caught in the removable bag thereby, removing need to pick up feces off of ground with hands. Thereafter, the removable bag is taken off the dog and disposed. Moreover, there is no harm to the grass on the ground due to the dog's urine as the dog's urine is collected in the removable bag.

Prior technology does not utilizes the use of a reusable water resistant cloth material bag that can be used with or without a disposable bag can be attached or inserted to catch excrement or urine.

Do not use an absorbent lining in bag for urine that may prevents spillage or splashing.

Do not utilizes the tail to aligned the bag directly over the anus opening to catch the feces.

Do not utilizes a water resistant cloth material bag that can be used with or without a disposable bag directly on the animal's body to catch waste;

a harness that can be worn by a dog to catch urine, feces or both forms of waste.

Do not utilizes a harness that is made to fit comfortable with straps fastening around the chest, to the tail and

the bag to catch urine may be lined with a disposable absorbent lining that soaks up the urine as it comes into contact;

the harness may be produced in assorted colors to accommodate user preferences; the water resistant cloth material bag may be produced in assorted colors to accommodate user preferences;

the exact dimensions, materials used for construction and method of operation of Doggie's Bathroom Bag may vary upon manufacturing

### BRIEF SUMMARY OF THE INVENTION

The primary object of the invention is to provide a simple way to clean up dogs excrement and urine without having to come in contact with the excrement or urine.

Another object of the invention is to provide a waste management system that attaches to the animal without causing harm to the dog.

Another object of the invention is to provide a waste management system that don't allow excrement to make contact with the dog's body.

A further object of the invention is to provide a waste management system that permits dog to have normal elimination of excrement falling away from the dog's body and not coming into contact with the waste.

Yet another object of the invention is to provide a waste management system that allows for the dog's normal behavior when eliminating excrement without the need of the pet owner to pick up excrement off the ground.

Still yet another object of the invention is to provide a better way of keeping the environment free of dogs' excrement.

Another object of the invention is to provide a cleaner way of caring for dog's excrement needs without the need to wipe, or clean, or bath the dog when used.

Another object of the invention is to provide a clean and humane way to take care of a dog on a walk, or at the dog park, eliminating 4 to 5 times within a 30 minute period—having a replaceable bag that easily attached and detach without coming into contact with the excrement, and no need to clean the dog.

A further object of the invention is to provide a cleaner way of handling dog's excrement that decrease contact with bacteria and germs.

Yet another object of the invention is to provide a more hygienic way of handling dog's excrement.

Still yet another object of the invention is to provide a way of catching and collecting dog's excrement and urine as it is eliminated from the dog's body without coming into physical contact with waste product.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Doggie's Bathroom Bag comprising: a water resistant cloth material bag that can be used with or without a disposable bag directly on the animal's body to catch waste, a harness that can be worn by a dog to catch urine, feces or both forms of waste, this item may be a harness with the removable water resistant cloth material bag & disposable bag attach directly to it. There may be a back strap that may connect to a dog's collar by a clipping mechanism, there maybe two side straps that connect around the dog's chest, and straps connects to the side straps over the dogs shoulders behind the head, the sides and back straps maybe looped around the belly harness strap, the loop allows it to move from side to side to adjust into a comfortable and secure position once on the animal, the belly strap may utilize hook, loop fasteners, side release snaps, attached to the belly strap may be two nylon straps with female snaps on the end, these snaps may connect to their male counterparts once wrapped around the dog's hind legs, attached to the belly strap may be two nylon bra straps that wraps around and adjust to fit into a comfortable and secure position around the dog's hind legs, in between the hind straps may be a piece of water resistant cloth material or waterproof cardboard or a similar material, there may be a circular opening in the center that may be divided into two sections, the bottom section may be where a water resistant cloth material bag that can be used with or without a disposable bag can be attached or inserted, the top section may be split in the center, the dog's tail may be inserted through this spilt with hook, loop fasteners, and or side release snaps being employed for security, the bag may then be positioned over the front of the dog to catch urine, or the back of the dog to collect feces, a longer bag maybe position over both areas to catch all waste at the same time, the bag to catch urine may be lined with a disposable absorbent lining that soaks up the urine as it comes into contact, the harness may be produced in assorted colors to accommodate user preferences, the water resistant cloth material bag may be produced in assorted colors to accommodate user preferences, and the exact dimensions, materials used for construction and method of operation of Doggie's Bathroom Bag may vary upon manufacturing.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention shows an animal wearing the product with the bag in a urine collecting position.

FIG. 2 shows the product and a longer variation collecting feces.

FIG. 3 shows one view of the product.

FIG. 4 shows the unit from one angle.

FIG. 5 shows the unit with and without a bag in place.

FIG. 6 shows the unit detail of the back to go over the tail, bra strap that goes around the hind legs.

FIG. 7 shows the harness from middle to backend of harness.

FIG. 8 shows a side view of the back of the harness.

FIG. 9 shows the front half of the harness.

FIG. 10 shows the water resistance removable bag.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

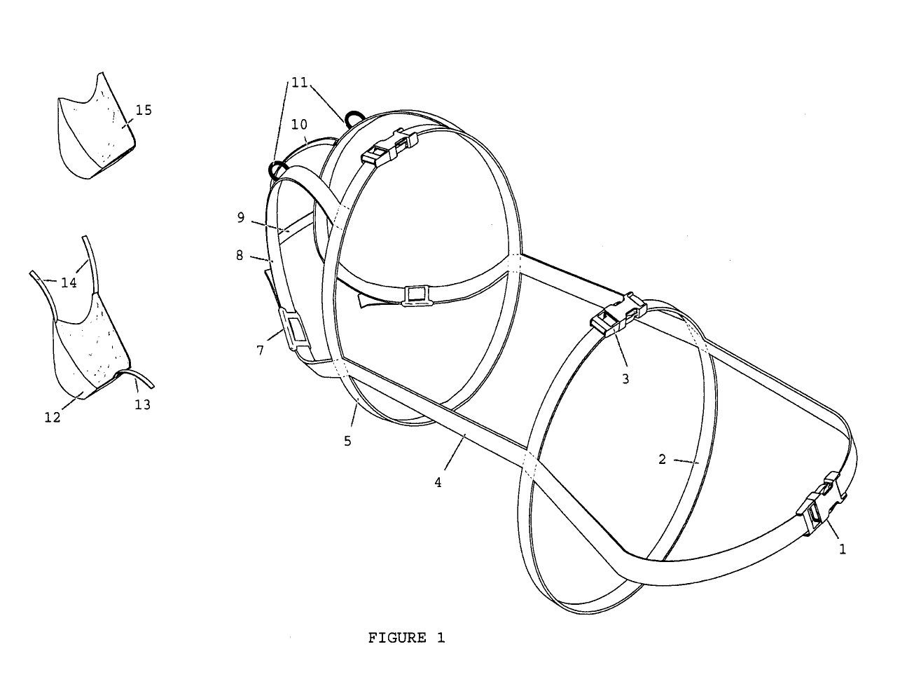

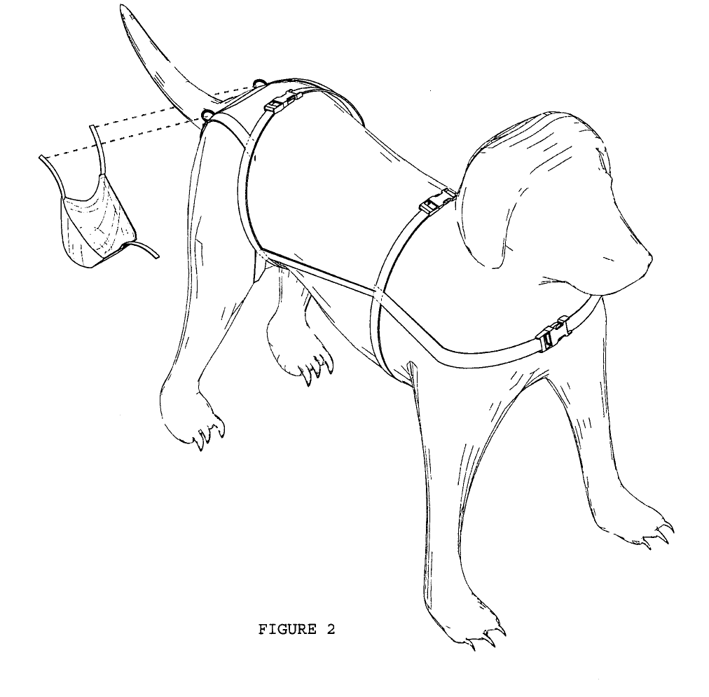

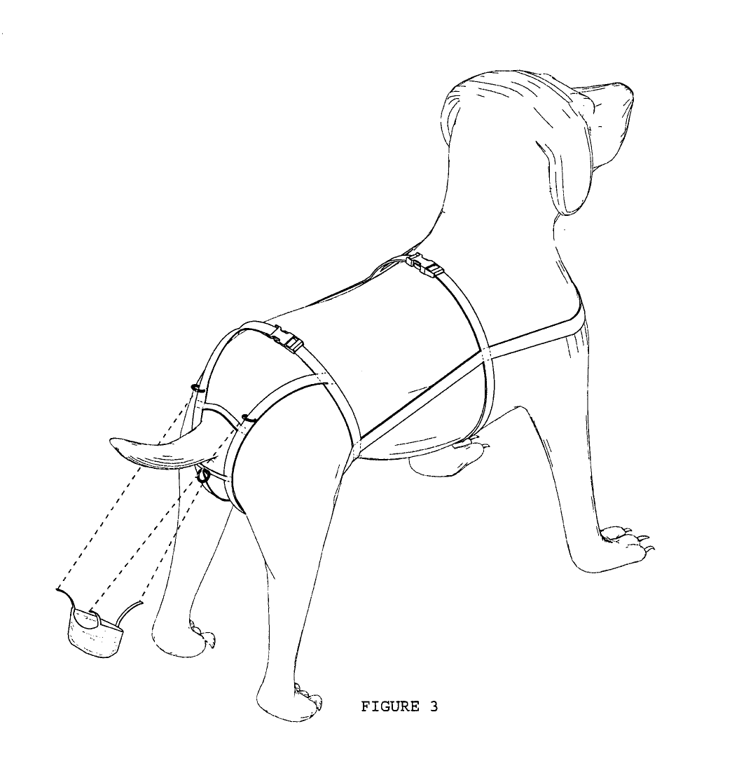

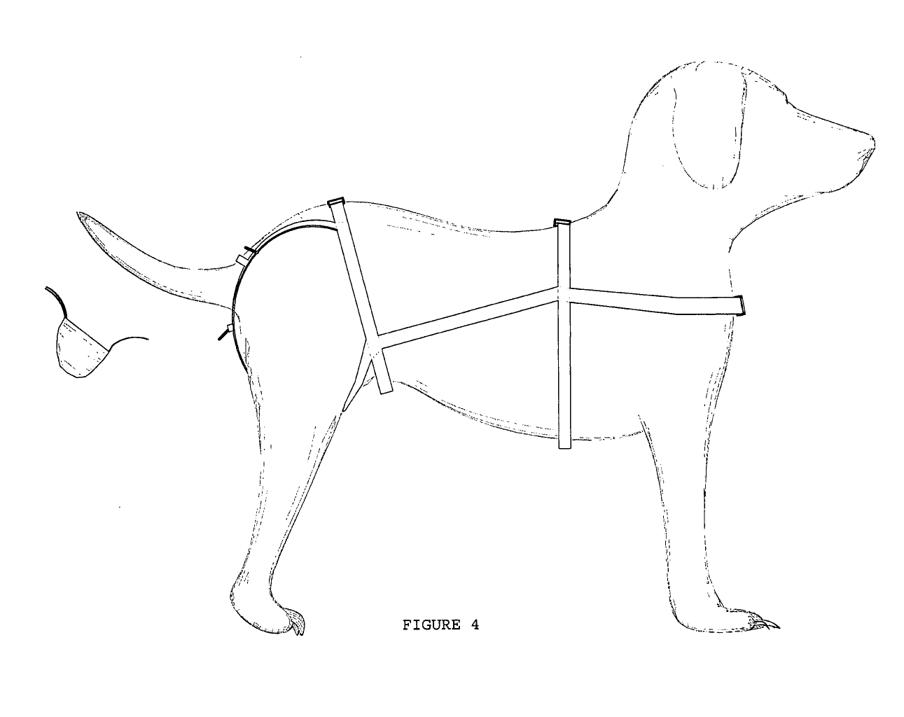

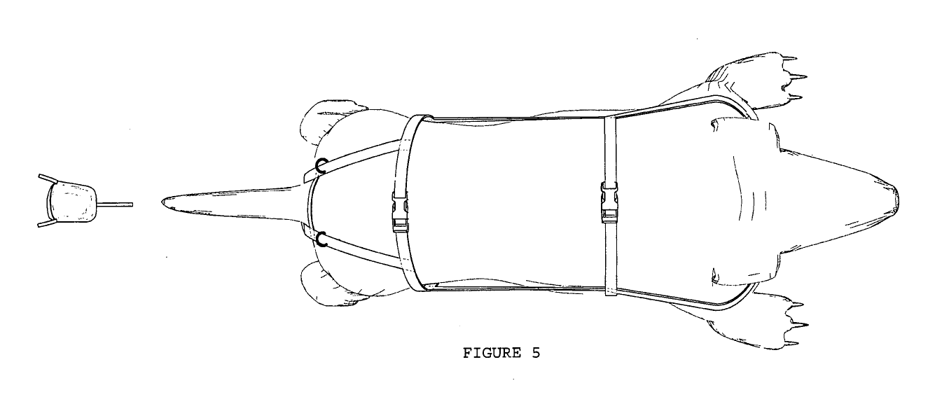

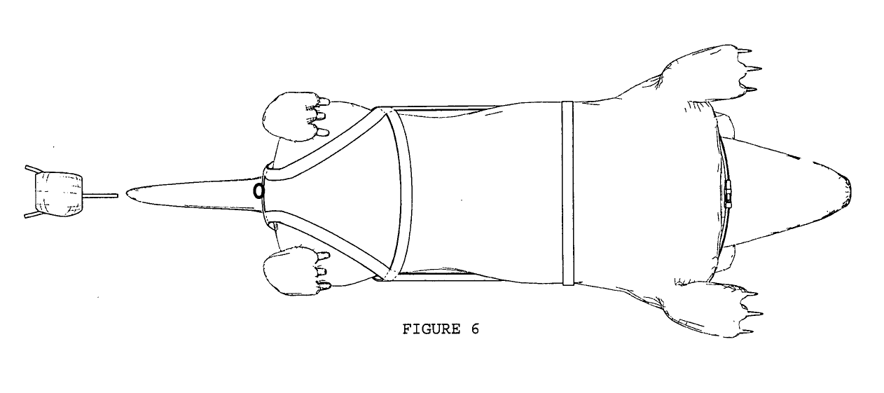

Turning first to FIG. 1, it shows an animal wearing the product. A process of Doggie's Bathroom Bag comprising of steps of: this item may be a harness with a removable water resistant cloth material bag that can be used with or without a disposable bag directly attach on the animal's body and worn to catch urine, feces or both forms of waste. The dog's tail is inserted through this spilt with hook, loop fasteners, and or side release snaps being employed for security. It is to be noted that the bag may then be positioned over the front of the dog to catch urine, or the back of the dog to collect feces. A longer bag maybe position over both areas to catch all waste at the same time, and the bag to catch urine may be lined with a disposable absorbent lining that soaks up the urine as it comes into contact. There may be a back strap that may connect to a dog's collar by a clipping mechanism; there maybe two side straps that connect around the dog's chest, and straps connects to the side straps over the dogs shoulders behind the head;

the sides and back straps maybe looped around the belly harness strap; the loop allows it to move from side to side to adjust into a comfortable and secure position once on the animal;

the belly strap may utilize hook, loop fasteners, side release snaps; attached to the belly strap may be two nylon straps with female snaps on the end, these snaps may connect to their male counterparts once wrapped around the dog's hind legs attached to the belly strap may be two nylon bra straps that wraps around and adjust to fit into a comfortable and secure position around the dog's hind legs; in between the hind straps may be a piece of water resistant cloth material or waterproof cardboard or a similar material;

there may be a circular opening in the center that may be divided into two sections; the bottom section may be where a water resistant cloth material bag that can be used with or without a disposable bag can be attached or inserted; the top section may be split in the center; the dog's tail may be inserted through this spilt with hook, loop fasteners, and or side release snaps being employed for security; the bag may then be positioned over the front of the dog to catch urine, or the back of the dog to collect feces; a longer bag maybe position over both areas to catch all waste at the same time; the bag to catch urine may be lined with a disposable absorbent lining that soaks up the urine as it comes into contact;

the harness may be produced in assorted colors to accommodate user preferences; the water resistant cloth material bag may be produced in assorted colors to accommodate user preferences; the exact dimensions, materials used for construction and method of operation of Doggie's Bathroom Bag may vary upon manufacturing

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Doggie's Bathroom Bag comprising:
a water resistant cloth material bag that can be used with or without a disposable bag directly on the animal's body to catch waste;
a harness that can be worn by a dog to catch urine, feces or both forms of waste;
this item may be a harness with the removable water resistant cloth material bag & disposable bag attach directly to it;
There may be a back strap that may connect to a dog's collar by a clipping mechanism;
there maybe two side straps that connect around the dog's chest, and straps connects to the side straps over the dogs shoulders behind the head;
the sides and back straps maybe looped around the belly harness strap;
the loop allows it to move from side to side to adjust into a comfortable and secure position once on the animal;
the belly strap may utilize hook, loop fasteners, side release snaps;
attached to the belly strap may be two nylon straps with female snaps on the end, these snaps may connect to their male counterparts once wrapped around the dog's hind legs;
attached to the belly strap may be two nylon bra straps that wraps around and adjust to fit into a comfortable and secure position around the dog's hind legs;
in between the hind straps may be a piece of water resistant cloth material or waterproof cardboard or a similar material;
there may be a circular opening in the center that may be divided into two sections;
the bottom section may be where a water resistant cloth material bag that can be used with or without a disposable bag can be attached or inserted;
the top section may be split in the center,
the dog's tail may be inserted through this spilt with hook, loop fasteners, and or side release snaps being employed for security;
the bag may then be positioned over the front of the dog to catch urine, or the back of the dog to collect feces;
a longer bag maybe position over both areas to catch all waste at the same time;
the bag to catch urine may be lined with a disposable absorbent lining that soaks up the urine as it comes into contact;
the harness may be produced in assorted colors to accommodate user preferences;
the water resistant cloth material bag may be produced in assorted colors to accommodate user preferences; and
the exact dimensions, materials used for construction and method of operation of Doggie's Bathroom Bag may vary upon manufacturing.

2. A process for Doggie's Bathroom Bag comprising the steps of:
a water resistant cloth material bag that can be used with or without a disposable bag directly on the animal's body to catch waste;
a harness that can be worn by a dog to catch urine, feces or both forms of waste;
this item may be a harness with the removable water resistant cloth material bag & disposable bag attach directly to it;
There may be a back strap that may connect to a dog's collar by a clipping mechanism;
there maybe two side straps that connect around the dog's chest, and straps connects to the side straps over the dogs shoulders behind the head;
the sides and back straps maybe looped around the belly harness strap;
the loop allows it to move from side to side to adjust into a comfortable and secure position once on the animal;
the belly strap may utilize hook, loop fasteners, side release snaps;
attached to the belly strap may be two nylon straps with female snaps on the end, these snaps may connect to their male counterparts once wrapped around the dog's hind legs;
attached to the belly strap may be two nylon bra straps that wraps around and adjust to fit into a comfortable and secure position around the dog's hind legs;
in between the hind straps may be a piece of water resistant cloth material or waterproof cardboard or a similar material;
there may be a circular opening in the center that may be divided into two sections;
the bottom section may be where a water resistant cloth material bag that can be used with or without a disposable bag can be attached or inserted;
the top section may be split in the center;
the dog's tail may be inserted through this spilt with hook, loop fasteners, and or side release snaps being employed for security;
the bag may then be positioned over the front of the dog to catch urine, or the back of the dog to collect feces;
a longer bag maybe position over both areas to catch all waste at the same time;
the bag to catch urine may be lined with a disposable absorbent lining that soaks up the urine as it comes into contact;
the harness may be produced in assorted colors to accommodate user preferences;
the water resistant cloth material bag may be produced in assorted colors to accommodate user preferences; and
the exact dimensions, materials used for construction and method of operation of Doggie's Bathroom Bag may vary upon manufacturing.
